(19) United States
(12) Patent Application Publication
(10) Pub. No.: US 2026/0017072 A1
(43) Pub. Date: Jan. 15, 2026

(54) SYSTEMS AND METHODS FOR AUTOMATED INTERFACE ELEMENT GENERATION AND PRESENTATION

(71) Applicant: Walmart Apollo, LLC, Bentonville, AR (US)

(72) Inventors: Sreejith Kallummil, Palakkad (IN); Sunil Rudresh, Bangalore (IN); Anuranjan Kumar, Bangalore (IN); Nayan Gupta, Bengaluru (IN); Anwesha Bhowmik, Marathahalli (IN); Pritam Prakash, Bangalore (IN); Nikul Atmaram Prajapati, Bengaluru (IN); Girish Thiruvenkadam, Bangalore (IN); Suman Kumar, Bangalore (IN); Hari Prasad Piridi, Bengaluru (IN); Rahul Ghosh, Bangalore (IN); Kannan Achan, Saratoga, CA (US); Anurag Katiyar, Whitefield (IN)

(21) Appl. No.: 19/228,995

(22) Filed: Jun. 5, 2025

Related U.S. Application Data
(60) Provisional application No. 63/668,963, filed on Jul. 9, 2024.

(51) Int. Cl. G06F 9/451

(52) U.S. Cl. CPC G06F 9/451

(57) ABSTRACT

System and methods for generating user interface elements are disclosed. Generating user interface elements includes receiving a request for interface elements associated with at least one of one or more candidate items, generating a user affinity score for the candidate interface elements and generating a candidate item affinity score for the candidate items and the candidate interface elements. In response to the request for interface elements, generating a combined affinity score for each candidate item, generating a plurality of interface elements for the candidate items, ranking the plurality of interface elements based on the combined affinity score for the interface elements and the candidate items, selecting a subset of the plurality of interface elements for the candidate items, and generating a set of instructions to cause the subset of the interface elements to be displayed in conjunction with the corresponding candidate items on a user interface.

### CROSS-REFERENCE TO RELATED APPLICATIONS

This application claims priority to Provisional Application No. 63/668,963, filed on Jul. 9, 2024 and entitled “Systems and Methods for Automated Interface Element Generation and Presentation,” the contents of which are incorporated herein in their entirety.

### TECHNICAL FIELD

This application relates generally to the automated generation of user interface elements, and more particularly, to the automated generation of interface elements presented in conjunction with candidate items.

### BACKGROUND

Some current user interfaces, such as e-commerce interfaces, are configured to be displayed in conjunction with interface elements representative of items in a network catalog. When a user is browsing items within a catalog, such as on a browse page or search page on an e-commerce website, one or more interface elements are presented on the user interface in conjunction with items to convey additional information related to an item, such as indicating to the user a special feature of the product. Current e-commerce interfaces may have limited space to present interface elements where a user may be overwhelmed, such that the additional interface elements are no longer helpful and may, in some instances, become distracting and/or limit a user's interactions with an interface.

### SUMMARY

In various embodiments, a system is disclosed. The system includes a non-transitory memory having instructions stored thereon and a processor configured to read the instructions to receive a request for one or more interface elements associated with at least one of one or more candidate items, generate a user affinity score for each of the one or more candidate interface elements based on user historical user interaction data, and generate a candidate item affinity score for each of the at least one of one or more candidate items and each of the one or more candidate interface elements based on historical item interaction data. In response to the request for one of or more interface elements, the processor is further configured to read the instructions to generate a combined affinity score for each candidate item of the at least one of one or more candidate items. The combined affinity score is generated by combining the user affinity score and the candidate item affinity score for each of the one or more candidate interface elements. The processor is further configured to read the instructions to generate a plurality of interface elements for the at least one of one or more candidate items, rank the plurality of interface elements based on the combined affinity score for each of the interface elements, and, for each of the at least one of one or more candidate items, select a subset of the plurality of interface elements for the at least one of one or more candidate items. The subset of the plurality of interface elements includes interface elements of the plurality of interface elements having a highest ranking. The processor is further configured to read the instructions to generate a set of instructions to cause the subset of the of the plurality of interface elements to be displayed in conjunction with the corresponding at least one of the one or more candidate items on a user interface.

In various embodiments, a computer implemented method is disclosed. The computer implemented method includes a step of receiving a request for one or more interface elements associated with at least one of one or more candidate items. The method includes steps of generating a user affinity score for each of the one or more candidate interface elements based on user historical user interaction data, and generating a candidate item affinity score for each of the at least one of one or more candidate items and each of the one or more candidate interface elements based on historical item interaction data. In response to the request for one of or more interface elements the method further includes a step of generating a combined affinity score for each candidate item of the at least one of one or more candidate items. The combined affinity score is generated by combining the user affinity score and the candidate item affinity score for each of the one or more candidate interface elements. The method further includes steps of generating a plurality of interface elements for the at least one of one or more candidate items, ranking the plurality of interface elements based on the combined affinity score for each of the interface elements and for each of the at least one of one or more candidate items, and selecting a subset of the plurality of interface elements for the at least one of one or more candidate items. The subset of the plurality of interface elements includes interface elements of the plurality of interface elements having a highest ranking. The method further includes a step of generating a set of instructions to cause the subset of the of the plurality of interface elements to be displayed in conjunction with the corresponding the at least one of the one or more candidate items on a user interface.

In various embodiments, a non-transitory computer-readable storage medium comprising executable instructions thereon is disclosed. When the executable instructions are executed by one or more processors of a computing device, the instructions cause the one or more processors to receive a request for one or more interface elements associated with at least one of one or more candidate items, generate a user affinity score for each of the one or more candidate interface elements based on user historical user interaction data, and generate a candidate item affinity score for each of the at least one of one or more candidate items and each of the one or more candidate interface elements based on historical item interaction data. In response to the request for one of or more interface elements, the instructions further cause the processor to generate a combined affinity score for each candidate item of the at least one of one or more candidate items. The combined affinity score is generated by combining the user affinity score and the candidate item affinity score for each of the one or more candidate interface elements. The instructions further cause the processor to generate a plurality of interface elements for the at least one of one or more candidate items, rank the plurality of interface elements based on the combined affinity score for each of the interface elements and for each of the at least one of one or more candidate items, select a subset of the plurality of interface elements for the at least one of one or more candidate items. The subset of the plurality of interface elements includes interface elements of the plurality of interface elements having a highest ranking. The instructions further cause the processor to generate a set of instructions to cause the subset of the of the plurality of interface elements to be displayed in conjunction with the corresponding the at least one of the one or more candidate items on a user interface.

### BRIEF DESCRIPTION OF THE DRAWINGS

The features and advantages of the embodiments described herein will be more fully disclosed in, or rendered obvious by the following detailed description of the preferred embodiments, which are to be considered together with the accompanying drawings wherein like numbers refer to like parts and further wherein:

FIG. 1 illustrates an example network environment configured to provide generation and selection of interface elements for a user interface, in accordance with some embodiments;

FIG. 2 illustrates an example computer system configured to implement one or more processes, in accordance with some embodiments;

FIGS. 3A and 3B are example flowcharts illustrating interface element generation and selection methods, in accordance with some embodiments;

FIG. 4A is an example process flow illustrating various steps of the interface element generation and selection methods of FIGS. 3A and 3B, in accordance with some embodiments;

FIG. 4B is an example process flow illustrating various steps in determining the user affinity score, in accordance with some embodiments;

FIG. 4C is an example process flow illustrating various steps in determining the candidate item affinity score, in accordance with some embodiments;

FIG. 4D is an example user interface displaying one or more candidate items, in accordance with some embodiments;

FIG. 4E is another example of a user interface displaying one or more candidate items, in accordance with some embodiments;

FIGS. 5A and 5B illustrate one or more example equations used in one or more of the steps in FIG. 3 and FIG. 4A, in some embodiments;

FIG. 6 illustrates an example artificial neural network, in accordance with some embodiments;

FIG. 7 illustrates an example tree-based artificial neural network, in accordance with some embodiments;

FIG. 8 illustrates an example deep neural network (DNN), in accordance with some embodiments;

FIG. 9 is an example flowchart illustrating a training method for generating a trained machine learning model, in accordance with some embodiments; and

FIG. 10 is an example process flow illustrating various steps of the training method of FIG. 9, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for generating and/or selecting interface elements. In various embodiments, generating one or more interface elements includes generating a combined user affinity score and candidate item affinity score such that a plurality of interface elements are selected. A request for one or more interface elements associated with at least one of one or more candidate items is received. A user affinity score is generated for each of the one or more candidate interface elements based on user historical user interaction data. A candidate item affinity score is generated for each of the at least one of one or more candidate items and each of the one or more candidate interface elements based on historical item interaction data. In response to the request for one of or more interface elements, a combined affinity score is generated for each candidate item of the at least one of one or more candidate items. The combined affinity score is generated by combining the user affinity score and the candidate item affinity score for each of the one or more candidate interface elements. A plurality of interface elements are generated for the at least one of one or more candidate items, the plurality of interface elements are ranked based on the combined affinity score for each of the interface elements, and, for each of the at least one of one or more candidate items, a subset of the plurality of interface elements are selected for the at least one of one or more candidate items. The subset of the plurality of interface elements includes interface elements of the plurality of interface elements having a highest ranking. A set of instructions is generated to cause the subset of the of the plurality of interface elements to be displayed in conjunction with the corresponding the at least one of the one or more candidate items on a user interface.

In some embodiments, systems, and methods for selecting interface elements includes one or more trained machine learning models. The trained machine learning models may include one or more models, such as trained causal inferencing models, deep neural networks, etc. As one example, a trained causal inferencing model may be configured to utilize one or more causal inferencing techniques to identify, rank, and/or otherwise select interface elements from a set of known interface elements for presentation in conjunction with one or more item interface elements on a user interface.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

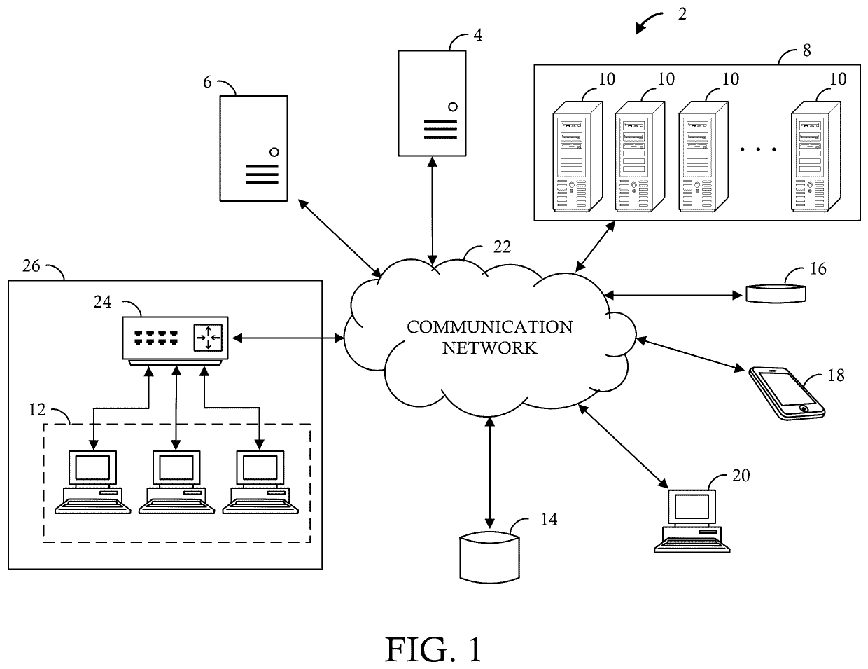

FIG. 1 illustrates a network environment 2 configured to provide the generation of interface elements, in accordance with some embodiments. The network environment 2 includes a plurality of devices or systems configured to communicate over one or more network channels, illustrated as a network cloud 22. For example, in various embodiments, the network environment 2 may include, but is not limited to, an interface generation computing device 4, a web server 6, a cloud-based engine 8 including one or more processing devices 10, a database 14, and/or one or more user computing devices 16, 18, 20 operatively coupled over the network 22. The interface generation computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the interface generation computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the interface generation computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the interface generation computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the interface generation computing device 4, for example. The workstation(s) 12 may communicate with the generation of interface elements computing device 4 over the communication network 22. The workstation(s) 12 may send data to, and receive data from, the generation of interface elements computing device 4. For example, the workstation(s) 12 may transmit data related to tracked operations performed at the physical location 26 to interface generation computing device 4.

Although FIG. 1 illustrates three user computing devices 16, 18, 20, the network environment 2 may include any number of user computing devices 16, 18, 20. Similarly, the network environment 2 may include any number of the interface generation computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the interface generation computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, and click on interface elements presented via the website, for example, in the search results. The website may capture these activities as user session data, and transmit the user session data to the interface generation computing device 4 over the communication network 22. The website may also allow the user to interact with one or more of interface elements to perform specific operations, such as selecting one or more items for further processing. In some embodiments, the web server 6 transmits user interaction data identifying interactions between the user and the website to the interface generation computing device 4.

In some embodiments, the interface generation computing device 4 may execute one or more models, processes, or algorithms, such as a machine learning model, deep learning model, statistical model, etc., to generate interface elements. The interface generation computing device 4 may transmit generated interface elements to the web server 6 over the communication network 22, and the web server 6 may display generated interface elements on the website to the user. For example, the web server 6 may display interface elements associated with and/or in conjunction with item interface elements to the user on a homepage, a catalog webpage, an item webpage, a window or interface of a chatbot, a search results webpage, or a post-transaction webpage of the website (e.g., as the user browses those respective webpages).

In some embodiments, the web server 6 transmits an interface generation request to the interface generation computing device 4. The interface generation request may be a request for an interface, such as a search query, item query, etc.

In some embodiments, a user submits a query on a website hosted by the web server 6. The web server 6 may send an interface generation request to the interface generation computing device 4. In response to receiving the interface generation request, the interface generation computing device 4 may execute one or more processes to identify and/or select interface elements for presentations with item interface elements and transmit a user interface including the selected interface elements to the web server 6 to be displayed to the user.

The interface generation computing device 4 is further operable to communicate with the database 14 over the communication network 22. For example, the interface generation computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the interface generation computing device 4, in some embodiments, the database 14 may be a local storage device, such as a hard drive, a non-volatile memory, or a USB stick. The generation of interface elements computing device 4 may store interaction data received from the web server 6 in the database 14. The interface generation computing device 4 may also receive from the web server 6 user session data identifying events associated with browsing sessions, and may store the user session data in the database 14.

In some embodiments, the interface generation computing device 4 generates training data for a plurality of models (e.g., machine learning models, deep learning models, statistical models, algorithms, etc.) based on user session data, interaction data, interface element data, etc. The interface generation computing device 4 and/or one or more of the processing devices 10 may train one or more models based on corresponding training data. The interface generation computing device 4 may store the models in a database, such as in the database 14 (e.g., a cloud storage database).

The models, when executed by the interface generation computing device 4, allow the interface generation computing device 4 to generation of interface elements. For example, the interface generation computing device 4 may obtain one or more models from the database 14. The interface generation computing device 4 may then receive, in real-time from the web server 6, an interface generation request. In response to receiving an interface generation request, the interface generation computing device 4 may execute one or more models to generate one or more interface elements.

In some embodiments, the interface generation computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, interface generation computing device 4 may generate one or more interface elements.

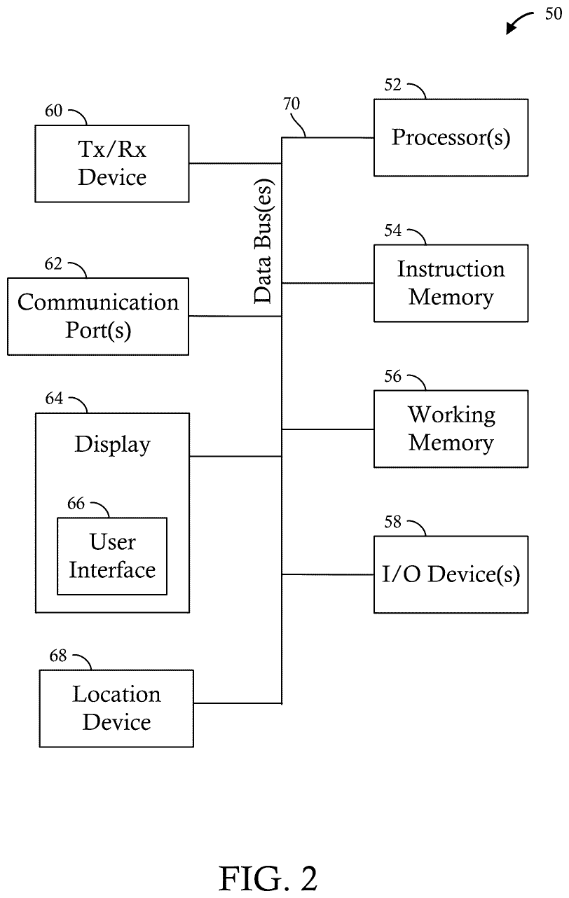

FIG. 2 illustrates a block diagram of a computing device 50, in accordance with some embodiments. In some embodiments, each of the interface generation computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for generation of interface elements, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with the generated interface elements. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

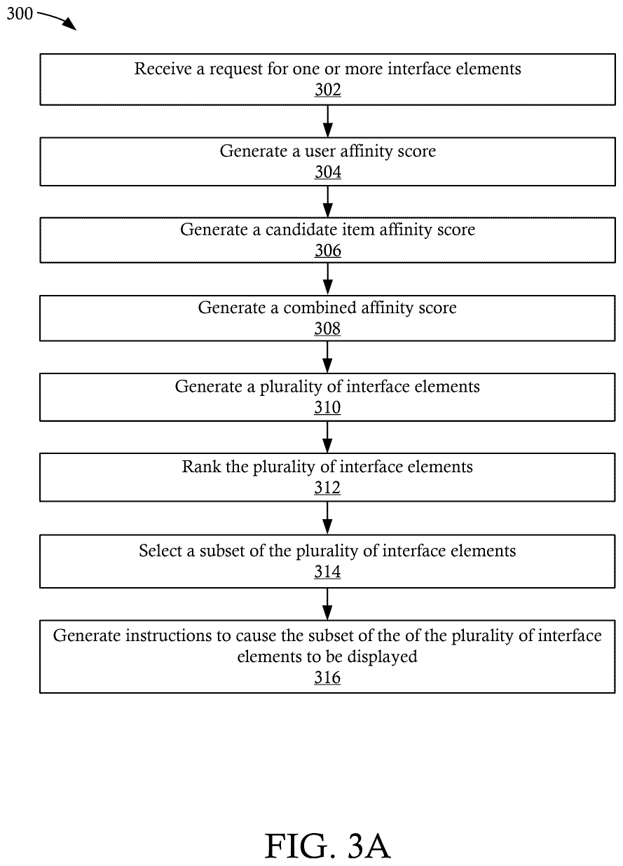

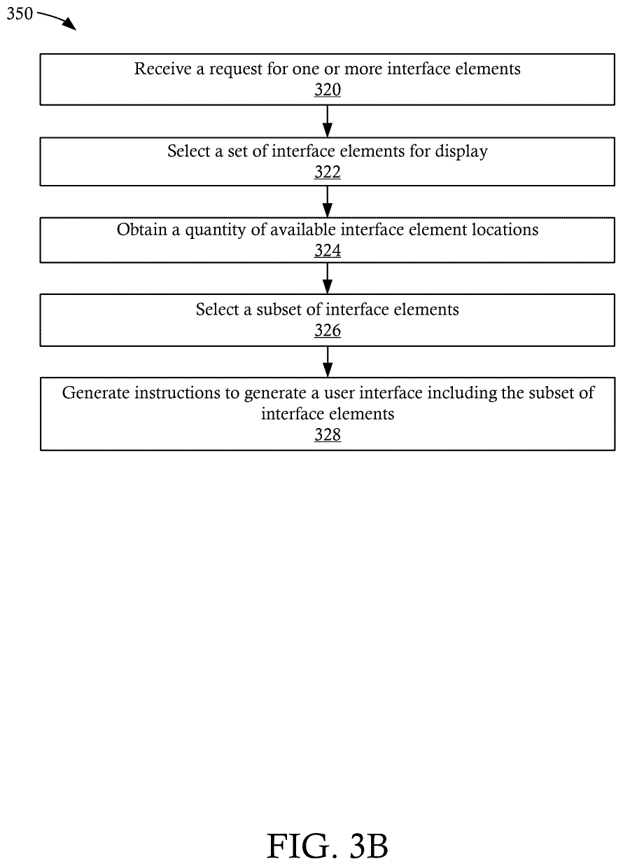

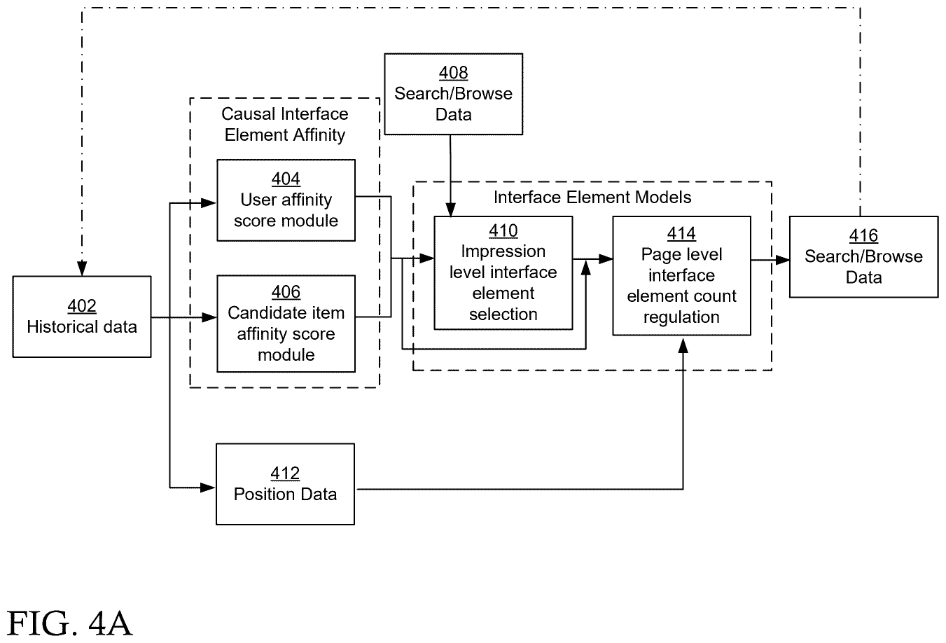

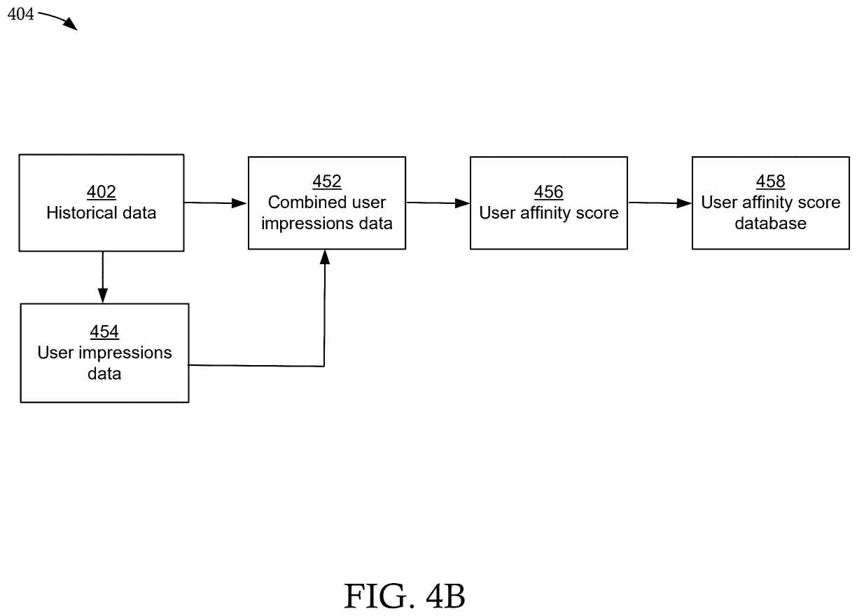

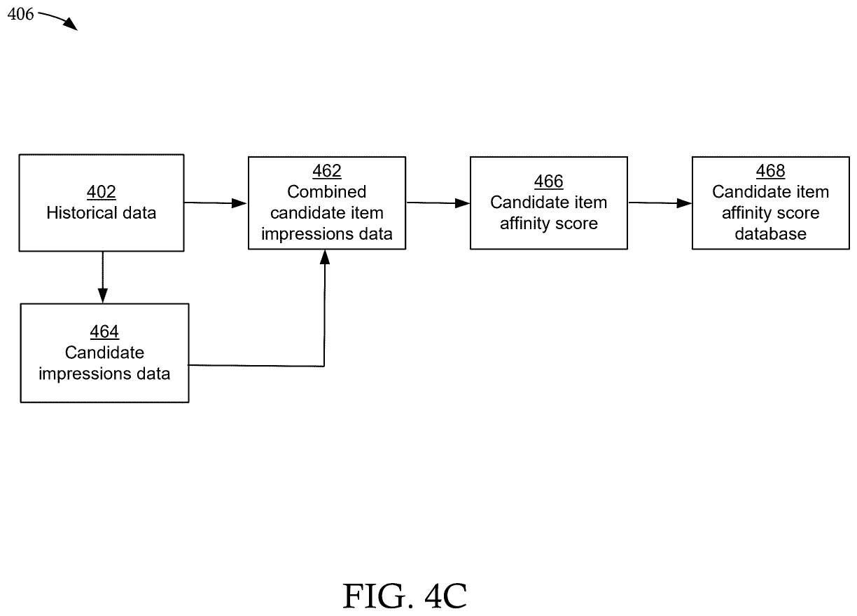

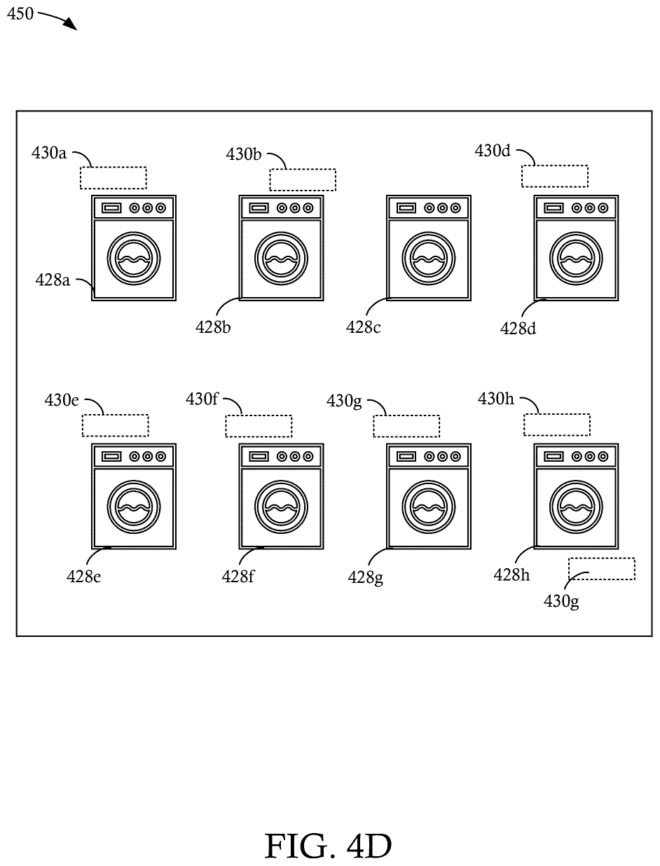

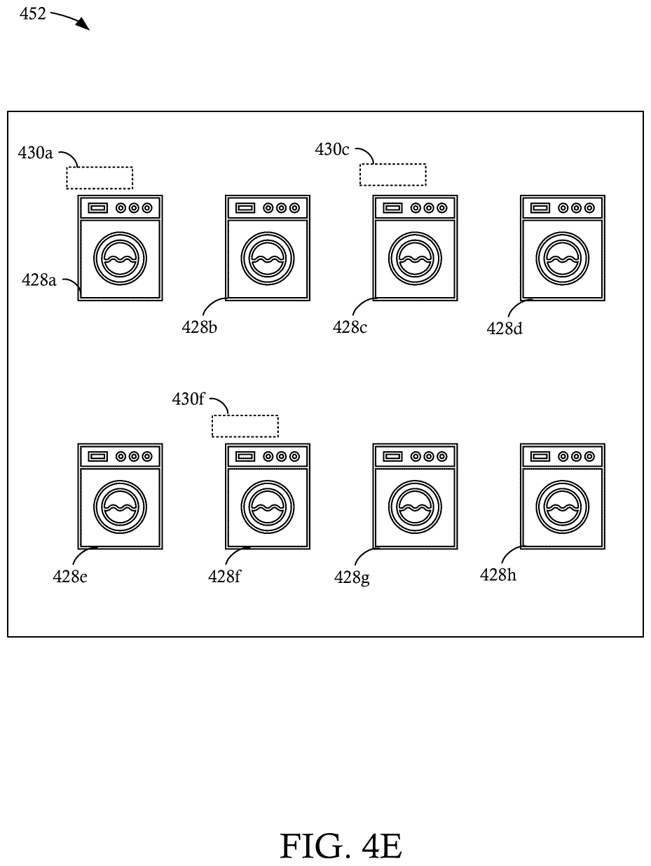

FIG. 3A is a flowchart illustrating a user interface and object item generation method 300, in accordance with some embodiments. FIG. 4A is a process flow 400 illustrating various steps of the user interface and object item generation method 300, in accordance with some embodiments. The user interface and object item generation method 300 is configured to generate instructions to cause a device to display one or more user interface elements in conjunction with a corresponding candidate item. The user interface and object item generation method 300 may be implemented by any suitable system, such as, for example the interface generation computing device 4 discussed above. Although embodiments are discussed herein including application of certain steps and/or processes, it will be appreciated that various elements of the user interface and object item generation method 300 may be performed in various orders and/or performed by additional and/or alternative processes or system elements as those disclosed herein.

At step 302, a request for one or more interface elements is obtained. For example, the request may be received from a user device, such as responsive to one or more user interactions implemented by the user device, and the one or more interface elements may be received from a data source, generated by a system executing user interface and object item generation method 300, and/or otherwise obtained. In some embodiments, the one or more interface elements include at least one or more text-based and/or graphic elements that are configured to emphasize a particular aspect of a candidate item presented in conjunction with the one or more interface elements (e.g., a star, a text-based phrase, etc.) that are stored in a database. The interface elements may also be emblems, badges, and/or symbols presented in conjunction with (e.g., within the vicinity of) a candidate item. The request for one or more interface elements may include a user visiting a landing page associated with the candidate object and/or a page associated with a plurality of candidate objects (e.g., the landing page for a television or the results of a search for television that displays multiple different types or brands of televisions.). An interface element may be associated with a candidate item in accordance with a determination that the interface element is within a certain distance of the candidate item on the user interface. For example, the interface element may be above the image and/or description for a candidate item, next to the image/description, and/or below it. In some embodiments, the database includes at least one or more candidate objects such as a items in an online ecommerce catalogue.

At step 304, a user affinity score is generated. The user affinity score may be generated by a user affinity score module 404. In some embodiments, the user affinity score is calculated based on historical user interaction data. Historical user interaction data may be included in the historical data 402 which contains historical impressions by a user. The user affinity score may measure the impact an interface element has on a respective user. For example, when a user has selected an object item that has a respective interface element, an impression may be stored in the historical data 402 and used for interface determination for the respective user. Observed historical impressions may include, but are not limited to, position, candidate item attributes, query type, display, application or website, search and browse, etc. and are stored in the historical data 402. In some embodiments, the user affinity scores are stored in a user affinity database.

In some embodiments, when a user has low or zero exposure to a respective interface element, the user will be segmented (e.g., grouped) with other users based on feature similarities, profile similarities, and/or personas. For example, when a user has an account associated with an e-commerce site and/or has one or more prior interactions with one or more items (e.g., adding one or more items to a cart) interaction history of the user may be used to segment the user into a group to provide additional historical data impressions for one or more determinations. A user affinity score may be computed at a user segment level by pooling impressions for all users in a segment in scenarios where users have low exposure to certain badges.

At step 306, a candidate item affinity score is generated. The candidate item affinity score may be generated by a candidate item affinity score module 406. In some embodiments, the candidate item affinity score for each candidate item is calculated based on item historical impressions. Historical candidate item interaction data may be included in the historical data 402 which contains historical impressions associated with the candidate item. For example, an impression may include a number of times an item was selected (e.g., purchased or clicked) when a respective interface element was displayed in conjunction with the candidate item. Furthermore, the candidate item affinity score may be configured to measure an impact an interface element has on a respective candidate item, which is captured in the historical data 402 stored in a database. Observed historical impressions may include, but are not limited to, position, candidate item attributes, query type, display, application or website, search and browse, etc. A “good” quality candidate item will have a higher chance of getting clicked (e.g., determined in part by historical data 402) and receiving an interface element configured to highlight the respective candidate item to a user. In some embodiments, the user affinity scores are stored in a candidate item affinity database.

In some embodiments, when a candidate item has low or zero exposure to a respective interface element, the candidate item will be segmented (e.g., grouped) with one or more additional candidate items based on candidate item similarities such as, candidate item type (e.g., televisions with similar features), similarity in features (e.g., price), etc. For example, when one or more new smart televisions are added to an e-commerce catalog, each of the added televisions will have little to no data of interface elements associated with each of the candidate items. The new candidate items can be grouped with existing candidate items that are similar to the added candidate items to provide additional feature data for a determination. In some embodiments, the candidate item affinity score is computed at a candidate item segment level by pooling impressions for all the candidate items in a segment in scenarios where the candidate items have had low exposure to respective interface elements.

At step 308, in response to a request for one or more interface elements, a combined affinity score is generated. In some embodiments, the combined affinity score for each candidate item is generated by combining the user affinity score and candidate item affinity score. In some embodiments the combined affinity score is based on the product of the user affinity score and the candidate item affinity score. The combined affinity score may be used as input to interface element selection logic to support finding the interface element with the highest score.

At step 310, in response to a request for one or more interface elements, a plurality of interface elements are generated. While the user is viewing one or more candidate items on a web page or application, a plurality of interface elements associated with the candidate items shown on the page are generated and associated based on a combined affinity score. In some embodiments, the interface elements associated with the viewable candidate items are a subset of the total number of interface elements available in the database. This subset of interface elements is determined based on which interface elements are associated with the viewable candidate objects are stored in the database. For example, when a viewable candidate object is associated with twelve distinct interface elements, each of the twelve interface elements will appear in the plurality of interface elements.

At step 312, in response to a request for one or more interface elements, the plurality of interface elements are ranked. In some embodiments, the plurality of interface elements are ranked based on the combined affinity score for each of the interface elements and for each of the at least one of one or more candidate items. In some embodiments, a user interface includes a limited number of locations at which one or more interface elements may be shown on a page, and a combined affinity score for each possible interface element associated with each of the at least one or more candidate items is generated and subsequently the interface elements are subsequently ranked for each candidate item.

At step 314 a subset of the plurality of interface items are selected for at least one or more of the candidate items. In some embodiments, the subset of the plurality of interface elements includes those with the highest ranking. Thus, in some embodiments, due to space constraints the highest ranked interface element for each candidate object item is selected to be displayed with the respective candidate object item.

At step 316, instructions are generated that cause the subset of the plurality of interface elements to be displayed on and/or in conjunction with a user interface. In some embodiments, the plurality of interface elements are displayed in conjunction with the corresponding at least one of the one or more candidate items on a user interface. In some embodiments, a plurality of interface elements are presented for a plurality of candidate items presented on the page, with each of the plurality of interface elements being associated with one of the plurality of candidate items. For example, when there is one candidate object there is only one interface element present and when there are eight candidate objects there are eight interface elements presented.

FIG. 3B is a flowchart illustrating a user interface and object item generation method 350, in accordance with some embodiments. FIG. 4A is a process flow 400 illustrating various steps of the user interface and object item generation method 350, in accordance with some embodiments. The user interface and object item generation method 350 is configured to generate instructions to display one or more user interface elements in conjunction with a corresponding candidate item. The user interface and object item generation method 350 may be implemented by any suitable system, such as, for example the interface generation computing device 4 discussed above. Although embodiments are discussed herein including application of certain steps and/or processes, it will be appreciated that various elements of the summary generation method 350 may be performed in various orders and/or performed by additional and/or alternative processes or system elements as those disclosed herein.

At step 320, a request for one or more interface elements is obtained. For example, the one or more interface elements can be received from a data source, generated by a system executing user interface and object item generation method 350, and/or otherwise obtained. In some embodiments, the one or more interface elements include at least one or more text-based or graphic elements that are configured to bring a user's attention to a particular aspect of a candidate item presented in conjunction with the one or more interface elements (e.g., a star, a catchy phrase, etc.) that are stored in a database. The interface elements can also be emblems, badges or symbols presented within the vicinity of a candidate item. The request for one or more interface elements can include a user visiting a landing page associated with the candidate object and/or a page associated with a plurality of candidate objects (e.g., the landing page for a television or the results of a search for television that displays multiple different types or brands of televisions.). An interface element is associated with a candidate item in accordance with a determination that the interface element is within a certain distance of the candidate item on the user interface. For example, the interface element could be above the image or description for a candidate item, next to the image/description, or below it. In some embodiments, the database includes at least one or more candidate objects such as a products in an online retailer product catalogue.

At step 322, a set of interface elements are selected for display. In some embodiments, a set of interface elements are selected for display in conjunction with at least one of the one or more candidate items based on a combined interface element affinity score for each of the one or more candidate items. The combined interface element affinity score may be a combination of a user affinity score 456, candidate item affinity score, and position data 412. For example, the set of interface elements may include those with the highest ranking. In some embodiments, the first subset of the at least one or more interface elements is selected based on a combined interface element affinity score for each one of the at least one or more candidate items. In some embodiments, the combined interface element affinity score is a combination of a user affinity score 456, candidate item affinity score, and position data 412. Examples of the user affinity score 456 and candidate item affinity scores are discussed above with reference to FIG. 3A. The position data 412 may include a probability of a candidate item being interacted with based on the position of the interface element. In some embodiments, the position data 412 includes an incremental click probability on an item in a position due to one or more additional interface element, as when there are two of the same or similar interface elements within close proximity to each other on an interface, the effectiveness of each of the interface elements may be reduced, causing a change in the click probability. Thus, in some embodiments, due to space constraints and/or additional considerations, a highest ranked interface element for each candidate object item is selected to be displayed with the respective candidate object item. In some embodiments, step 322 is performed in the impression level interface element selection 410, illustrated in FIG. 4A, based on the combined interface element affinity score. In some embodiments, the interface element models (e.g., impression level interface element selection 410 and page level interface element count regulation 414) are processes performed online and/or offline.

At step 324, a quantity of available interface element locations is obtained. The quantity may be based on a quantity of the one or more candidate items. In some embodiments, each candidate item is associated with one available interface element location such that the quantity of available interface element locations is equal to the number of candidate items. In some embodiments, more than one available interface element location associated with each candidate item such that the total number of available interface element locations is equal to the number of candidate items multiplied by the number of interface element positions.

At step 326, a subset of interface elements is selected. The subset of interface elements may be selected from the set of interface elements based on a first selection criteria. The first selection criteria are configured to identify interface elements that have a highest rating and characteristics that increase the probability that an accompanying candidate item will be selected. The quantity of interface elements in the subset of interface elements may be less than a quantity of available interface element locations in the user interface. In some embodiments, a percentage of the eligible user interface elements are selected based on the ability to improve the probability that they will encourage a user to click on an accompanying object item. In some embodiments, step 326 is performed in the page level interface element count regulation, illustrated in FIG. 4A, based on the first selection criteria.

At step 328, instructions are generated to cause the selected subset of interface elements to be displayed. In some embodiments, in accordance with a determination that the one or more candidate objects and/or interface elements are ready for presentation to a user, generate a set of instructions to cause a device to generate a user interface including the subset of interface elements displayed in conjunction with a corresponding one of the one or more candidate items. For example, if there are 9 candidate objects and the first selection criteria allows for 3 interface elements, the user interface will present the 3 interface elements and 9 candidate objects on the user interface.

FIG. 4B is a process flow illustrating various steps in determining the user affinity score, in accordance with some embodiments. One example of the user affinity score module 404 is illustrated in FIG. 4B. The historical data 402 includes impressions (e.g., user interactions such as clicks on a user interface) described above in conjunction with FIGS. 3A and 3B. Impressions may also include at least one of position, candidate item attributes, query type, display application/website, search/browse, etc. The user impressions data 454 may include a subset of the historical data for which a user interacted (e.g., clicked) with on a component (e.g., item) of the user interface when no interface element was present. The combined user impressions data 452 combines data including impressions associated when interface elements were present and user impressions data 454 where an interaction was present without an interface element present. Based on the combined interface element impressions data 452, a user affinity score 456 may be determined for each interface element such that each data point is associated with a user id and an interface element impression. The one or more user affinity scores 456 are stored in a user affinity score database 458. The steps performed at the user affinity score module 404 may be performed online and/or offline.

FIG. 4C is a process flow illustrating various steps in determining a candidate item affinity score, in accordance with some embodiments. One example of a candidate item affinity score module 406 is illustrated in FIG. 4C. The historical data 402 may include impressions as described above in conjunction with FIGS. 3A-4A. Candidate impressions data 464 may include a subset of the historical data for which an interaction (e.g., a click, a view, etc.) occurred for a candidate item when there was no interface element presented in conjunction with the candidate item. The combined candidate item impressions data 462 combines the candidate impressions data 464 associated with interactions with the candidate item while an interface element was presented in conjunction with the candidate item. Based on the combined candidate item impressions data 462, the candidate item affinity score 466 may be determined for each candidate item and interface element combination. The candidate item affinity scores may be stored in the candidate item affinity score database. The steps performed in the candidate item affinity score module 406 are performed online and/or offline.

FIG. 4D is an example user interface displaying one or more candidate items, in accordance with some embodiments. At step 316 described above in FIG. 3A, instructions are generated to display a plurality of interface elements in conjunction with candidate items. FIG. 4D further illustrates one example of an e-commerce interface 450 that includes a plurality of candidate items 428a-428h and interface elements 430a-430g. In some embodiments, a candidate item 428 (e.g., candidate item 428h) has one or more interface elements (e.g., interface elements 430h and 430g) presented in conjunction the respective candidate item 428h. Additionally, the number of candidate items displayed in FIG. 4D is non-limiting and may be 1, 2, n, etc. number of candidate items. FIG. 4D further illustrates the respective candidate items 428 presented in conjunction with at least one interface element 430.

FIG. 4E illustrates an example of a user interface displaying one or more candidate items, in accordance with some embodiments. At step 328, described above in FIG. 3B, instructions for displaying a user interface including the subset of interface elements are generated. For example, the method 350 may produce an optimized quantity of interface elements 430 to display in conjunction with the candidate items 428 on an e-commerce interface to reduce the probability of a user viewing a user interface becoming overwhelmed. FIG. 4E further illustrates candidate item 428a-428h (e.g., 8 candidate items in this example) and interface elements 430a, 430c, and 430f (e.g., 3 interface elements in this example). This example illustrates a ratio of three interface elements 430 to eight candidate items 428, however the ratio can be determined based on the probability of a user of interacting with one of the candidate items based on which interface element is present.

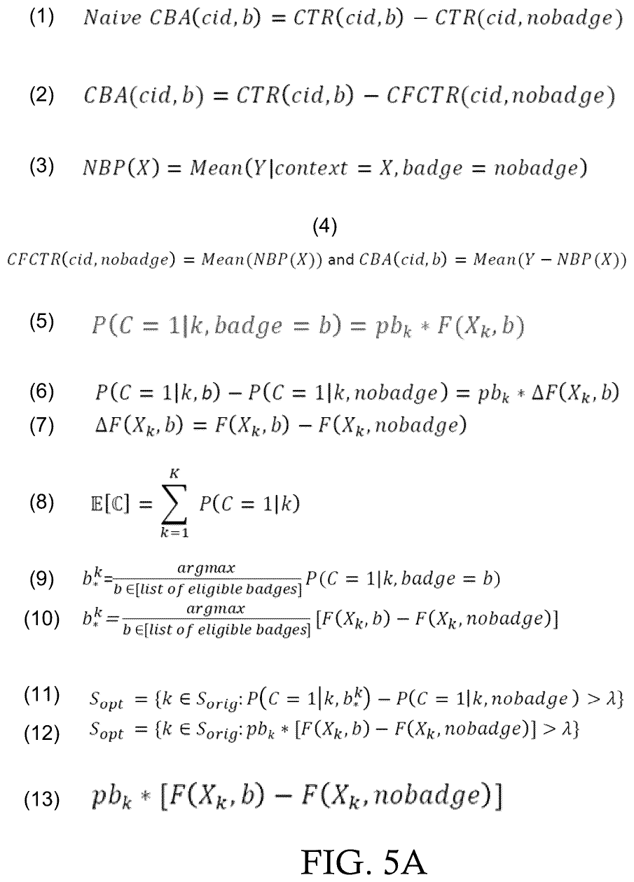

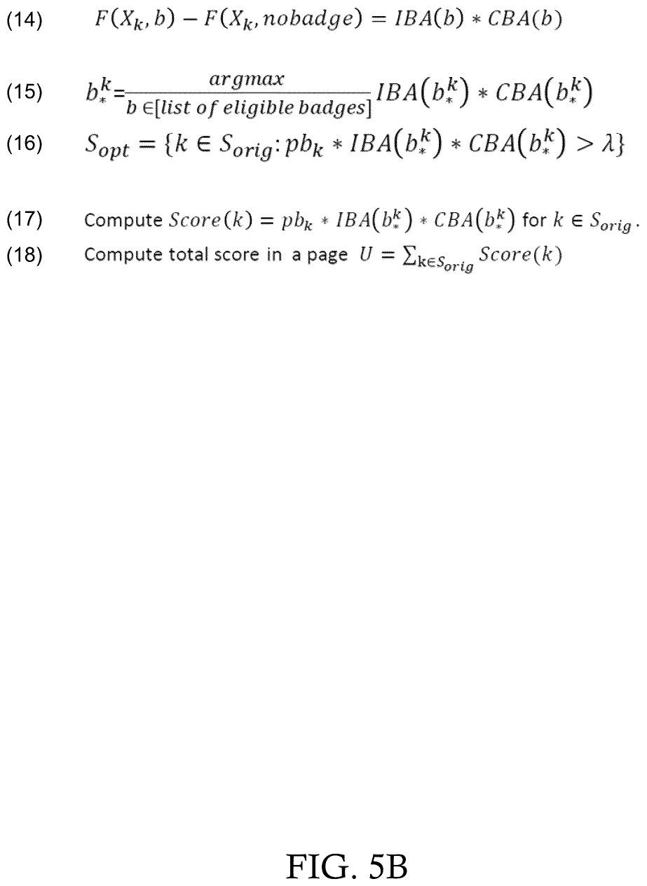

FIGS. 5A and 5B illustrates one or more equations used by one or more of the modules, in some embodiments. Equation (1) is used in the candidate item affinity score module 406 as described with respect to step 306. Equation (1) is a mathematical formulation for calculating the item object affinity score.

Equation (2) is used in the candidate item affinity score module 406 as described with respect to step 306. Equation (2) is a mathematical formula configured to determine the causal inference-based candidate object affinity score (e.g., and estimation).

Equation's (3) and (4) are used in the calculations with respect to the historical data 402. Equation's (3) and (4) are a mathematical formula configured to determine the no-candidate object click probability that are computable from historical data.

Equation (5) is used in page level interface module 414. Equation (5) is a mathematical formula configured to determine position bias click model (e.g., the probability of a click on an item in a kth position).

Equation's (6) and (7) are used in page level interface module 414. Equation's (6) and (7) are a mathematical formulas configured to determine the incremental click probability on an item at the kth position due to the interface element (b).

Equation (8) is used in page level interface module 414. Equation (8) is a mathematical formula configured to determine the expected number of clicks on a page with k items.

Equation's (9) and (10) are used in the impression level interface element selection module 410. Equation's (9) and (10) are mathematical formulas configured to identify the best interface element for all interface eligible interface eligible positions. Bk is the interface element that maximizes the click probability or relevance at position k.

Equation's (11) and (12) are used in page level interface module 414. Equation's (11) and (12) are mathematical formulas configured to identify the best interface element for all interface eligible interface eligible positions. Bk is the interface element that maximizes the click probability or relevance at position k.

Equation (13) is used in page level interface module 414. Equation (13) is a mathematical formula configured to determine the difference of click probabilities.

Equation (14) is used in page level interface module 414. Equation (14) is a mathematical formula used in a production model.

Equation's (15) and (16) are mathematical formulas configured to estimate the interface elements at the serving layer.

Equation's (17) and (18) are mathematical formulas configured to estimate the an interface element score.

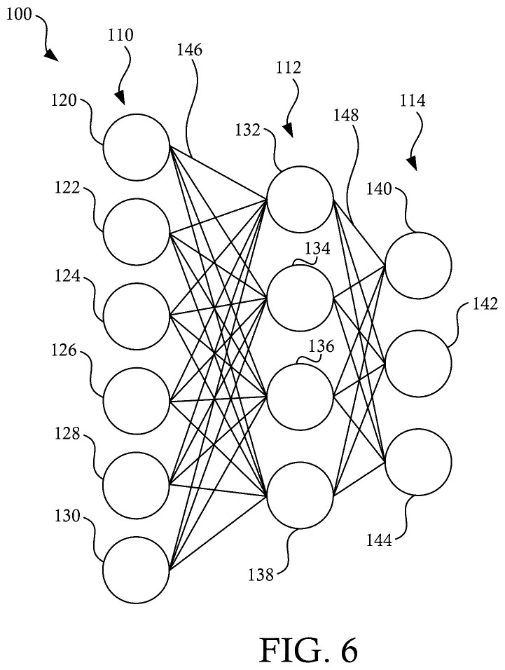

FIG. 6 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 6 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here,

$${x}_{i}^{( n )}$$

denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here

$${w}_{i , j}^{( m , n )}$$

denotes the weight of the edge between the i-th node 120-138 of the m-th layer 110, 112 and the j-th node 132-144 of the n-th layer 112, 114. Furthermore, the abbreviation

$${w}_{i , j}^{( n )}$$

is defined for the weight

$${w}_{i , j}^{( n , n + 1 )} .$$

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values

$${w}_{i , j}^{( m , n )}$$

for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${{w}^{′}}_{i , j}^{( n )} = {w}_{i , j}^{( n )} - γ \cdot {δ}_{j}^{( n )} \cdot {x}_{i}^{( n )}$$

wherein γ is a learning rate, and the numbers

$${δ}_{j}^{( n )}$$

may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on

$${δ}_{j}^{( n + 1 )} ,$$

if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and

$${y}_{j}^{( n + 1 )}$$

is the comparison training value for the j-th node of the output layer 114.

In some embodiments, the neural network 100 is configured, or trained, to automatically generate interface elements.

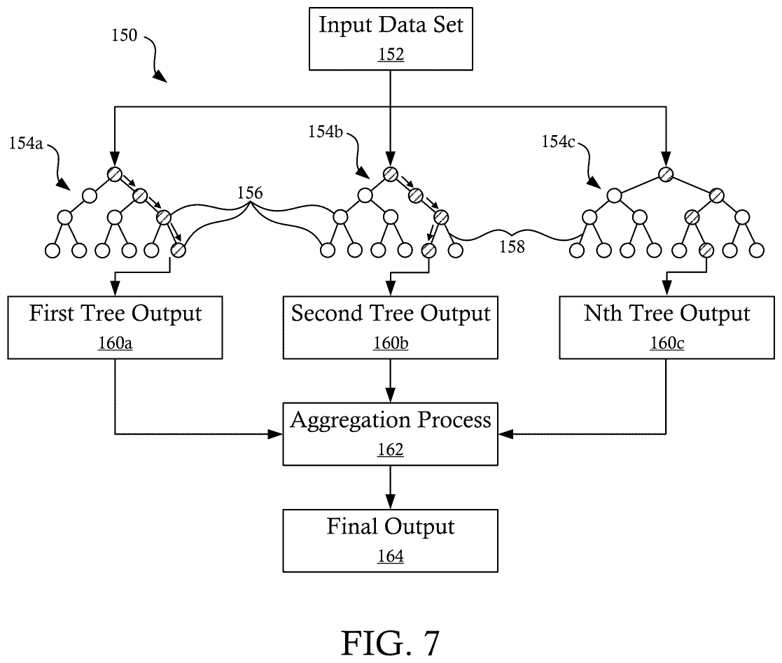

FIG. 7 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

In some embodiments, the tree-based neural network 150 is configured, or trained, to automatically generate interface elements.

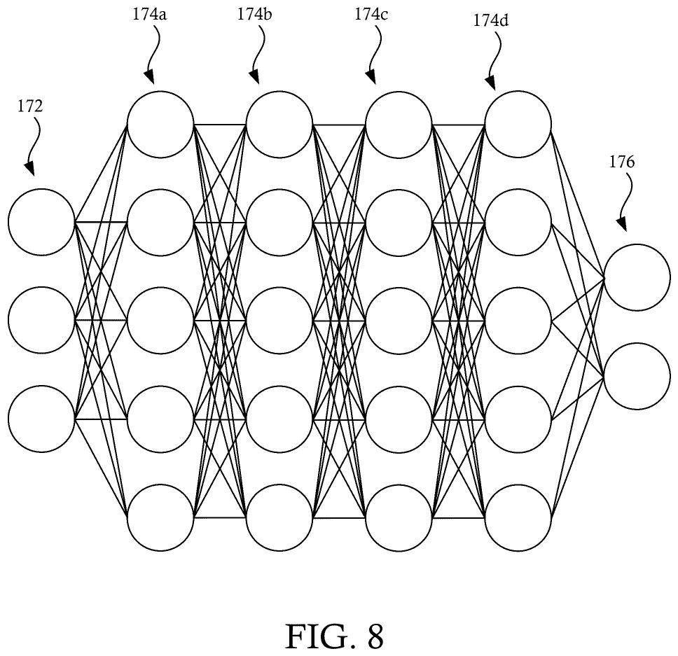

FIG. 8 illustrates a deep neural network (DNN) 170, in accordance with some embodiments. The DNN 170 is an artificial neural network, such as the neural network 100 illustrated in conjunction with FIG. 6, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( ⋯ ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + ⋯ + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )}$$

where d represents one or more features of the independent variable x.

Identification of highest ranked interface elements associated with one or more candidate items can be burdensome and time consuming for interface generation systems and the inclusion of such interface elements may be overwhelming and unproductive for users, especially if there are too many interface elements associated with candidate items presented to the user. Typically, a user may locate information regarding components of an interface, such as item components, by navigating a browse structure, sometimes referred to as a “browse tree,” in which interface pages or components are arranged in a predetermined hierarchy. Such browse trees typically include multiple hierarchical levels, requiring users to navigate through several levels of browse nodes or pages to arrive at an interface page of interest. Thus, the user frequently has to perform numerous navigational steps to arrive at a page containing information regarding interface components targeted towards their needs.

Systems including trained causal inferencing models and deep neural networks, as disclosed herein, significantly reduce this problem, allowing users to identify information regarding interface components, such as information conveyed via one or more highest ranked interface elements with fewer, or in some case no, active steps. For example, in some embodiments described herein, when a user is presented with an interface, only a set of n highest ranked interface elements may be presented in conjunction with interface components, each of which includes, or is in the form of, a link to an interface page. Each interface element or item component thus serves as a programmatically selected navigational shortcut to an interface page, allowing a user to bypass the navigational structure of the browse tree. Beneficially, programmatically identifying a set of highest ranked interface elements and presenting a user with navigations shortcuts based on those interface elements may improve the speed of the user's navigation through an electronic interface, rather than requiring the user to page through multiple other pages in order to locate the desired information via the browse tree or via a search function. This may be particularly beneficial for computing devices with small screens, where fewer interface elements are displayed to a user at a time and thus navigation of larger volumes of data is more difficult. For example, as explained in FIGS. 3A-5B, when an candidate item is displayed in conjunction with too many interface elements, the interface elements lose their effect in guiding a user to specific candidate items they are looking for. Thus a method to present the highest ranked set of interface elements and/or optimize the number of interface elements is needed to display an appropriate quantity and/or ratio of candidate items to interface elements.

It will be appreciated that systems and method configured to identify highest ranked interface elements and/or optimize of a number of interface elements, as disclosed herein, particularly on large datasets intended to be used in the context of ecommerce catalogs and interfaces, is only possible with the aid of computer-assisted machine-learning algorithms and techniques, such as causals inferencing models. In some embodiments, machine learning processes including causal inferencing models are used to perform operations that cannot practically be performed by a human, either mentally or with assistance, such as the generation of interface elements, selection of highest ranked interface elements, or optimization of the number of interface elements to be displayed. It will be appreciated that a variety of machine learning techniques can be used alone or in combination to generate causal inference models.

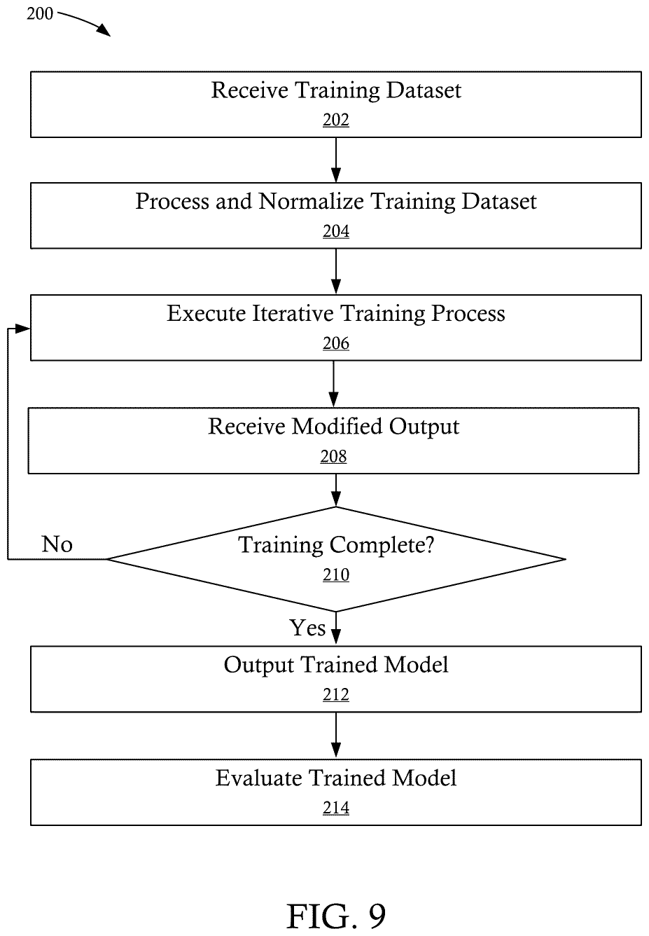

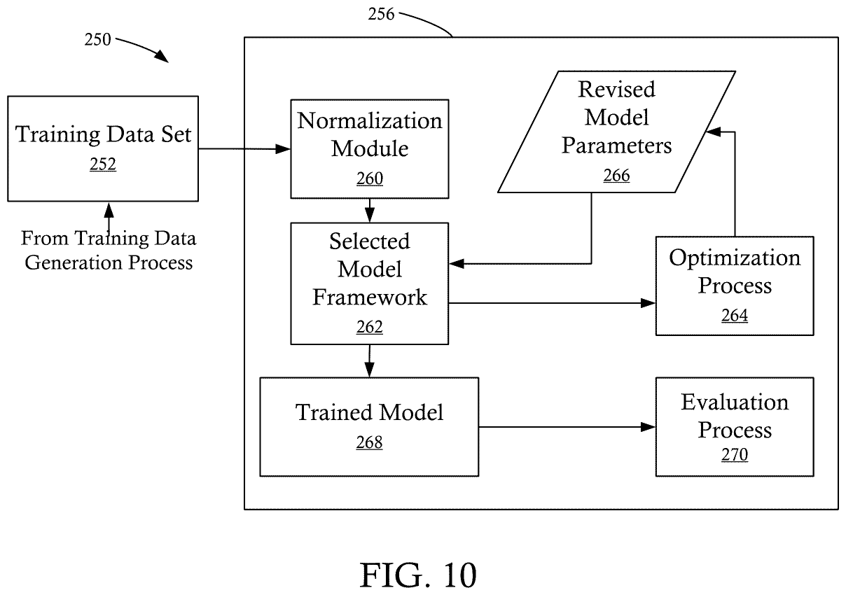

In some embodiments, the causal inference element affinity modules can include and/or implement one or more trained models, such as a causal inference model. In some embodiments, one or more trained models can be generated using an iterative training process based on a training dataset. FIG. 9 illustrates a method 200 for generating a trained model 256, such as a trained causal inference model, in accordance with some embodiments. FIG. 10 is a process flow 250 illustrating various steps of the method 200 of generating a trained model 256, in accordance with some embodiments. At step 202, a training dataset 252 is received by a system, such as a processing device 10. The training dataset 252 can include labeled and/or unlabeled data. For example, in some embodiments, historical data 402, search/browse data 408 and 416, user impressions data 544, user affinity score data from the user affinity score database 458, candidate impressions data 464, and candidate item affinity score data stored in the candidate item affinity score data base 468 are provided for use in training a model. In some embodiments, the training dataset 252 includes generated and/or tagged interface elements.

At optional step 204, the received training dataset 252 is processed and/or normalized by a normalization module 260. For example, in some embodiments, the training dataset 252 can be augmented by imputing or estimating missing values of one or more features associated with historical data 402, search/browse data 408 and 416, user impressions data 544, user affinity score 456 data from the user affinity score database 458, candidate impressions data 464, and candidate item affinity score data stored in the candidate item affinity score data base 468. In some embodiments, processing of the received training dataset 252 includes outlier detection configured to remove data likely to skew training of a causal inference model. In some embodiments, processing of the received training dataset 252 includes removing features that have limited value with respect to training of the causal inference model.

At step 206, an iterative training process is executed to train a selected model framework 262. The selected model framework 262 can include an untrained (e.g., base) machine learning model, such as untrained causals inference frameworks and/or a partially or previously trained model (e.g., a prior version of a trained model). The training process is configured to iteratively adjust parameters (e.g., hyperparameters) of the selected model framework 262 to minimize a cost value (e.g., an output of a cost function) for the selected model framework 262. In some embodiments, the cost value is related to generating interface elements.

The training process is an iterative process that generates set of revised model parameters 266 during each iteration. The set of revised model parameters 266 can be generated by applying an optimization process 264 to the cost function of the selected model framework 262. The optimization process 264 can be configured to reduce the cost value (e.g., reduce the output of the cost function) at each step by adjusting one or more parameters during each iteration of the training process.

After each iteration of the training process, at step 208, a determination is made whether the training process is complete. The determination at step 208 can be based on any suitable parameters. For example, in some embodiments, a training process can complete after a predetermined number of iterations. As another example, in some embodiments, a training process can complete when it is determined that the cost function of the selected model framework 262 has reached a minimum, such as a local minimum and/or a global minimum.

At step 210, a trained model 268, such as a trained causal inference model, is output and provided for use in a one or more computer implemented methods, such as method 300 and/or method 350, for example, to generate one or more interface elements. At optional step 212, a trained model 268 can be evaluated by an evaluation process 270. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model 214.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory having instructions stored thereon; and
a processor configured to read the instructions to:
receive a request for one or more interface elements associated with at least one of one or more candidate items;
generate a user affinity score for each of the one or more candidate interface elements based on user historical user interaction data;
generate a candidate item affinity score for each of the at least one of one or more candidate items and each of the one or more candidate interface elements based on historical item interaction data; and
responsive to the request for one of or more interface elements:
generate a combined affinity score for each candidate item of the at least one of one or more candidate items, wherein the combined affinity score is generated by combining the user affinity score and the candidate item affinity score for each of the one or more candidate interface elements;
generate a plurality of interface elements for the at least one of one or more candidate items;
rank the plurality of interface elements based on the combined affinity score for each of the interface elements and for each of the at least one of one or more candidate items;
select a subset of the plurality of interface elements for the at least one of one or more candidate items, wherein:
the subset of the plurality of interface elements includes interface elements of the plurality of interface elements having a highest ranking; and
generate a set of instructions to cause the subset of the of the plurality of interface elements to be displayed in conjunction with the corresponding the at least one of the one or more candidate items on a user interface.

2. The system of claim 1, wherein the processor is configured to read the instructions to input a data set comprising item attributes to a tree-based neural network and, in response, generate the plurality of interface elements for the at least one of one or more candidate items.

3. The system of claim 2, wherein the tree-based neural network includes a plurality of trained decision trees, and wherein the processor is configured to read the instructions to input at least a portion of the data set to each of the plurality of trained decision trees.

4. The system of claim 1, wherein the processor is configured to read the instructions to execute an artificial neural network and, in response, generate the plurality of interface elements for the at least one of one or more candidate items.

5. The system of claim 4, wherein the processor is configured to read the instructions to:
receive a training data set;
input the training data set into an untrained artificial neural network and, in response, adjust one or more parameters of the untrained artificial neural network;
determine that the artificial neural network is trained based on the adjusted one or more parameters; and
store the adjusted one or more parameters in a database, wherein the adjusted one or more parameters characterize the artificial neural network.

6. The system of claim 1, wherein the user historical user interaction data comprises a plurality of impressions.

7. The system of claim 6, wherein the plurality of impressions characterize at least one of a position, an item attribute, a query type, a display application, a website, a search, and a browse.

8. The system of claim 6, wherein the plurality of impressions comprise first impressions captured when at least a portion of the interface elements were present and second impressions captured when at least the portion of the interface elements were not present.

9. The system of claim 1, wherein the processor is configured to read the instructions to generate the combined affinity score based on computing a product of the user affinity score and the candidate item affinity score for each of the one or more candidate interface elements.

10. The system of claim 1, wherein the processor is configured to read the instructions to generate the set of instructions to cause the subset of the of the plurality of interface elements to be displayed within a predetermined distance of the at least one of one or more candidate on the user interface.

11. A computer implemented method, comprising:
receiving a request for one or more interface elements associated with at least one of one or more candidate items;
generating a user affinity score for each of the one or more candidate interface elements based on user historical user interaction data;
generating a candidate item affinity score for each of the at least one of one or more candidate items and each of the one or more candidate interface elements based on historical item interaction data; and
responsive to the request for one of or more interface elements:
generating a combined affinity score for each candidate item of the at least one of one or more candidate items, wherein the combined affinity score is generated by combining the user affinity score and the candidate item affinity score for each of the one or more candidate interface elements;
generating a plurality of interface elements for the at least one of one or more candidate items;
ranking the plurality of interface elements based on the combined affinity score for each of the interface elements and for each of the at least one of one or more candidate items;
selecting a subset of the plurality of interface elements for the at least one of one or more candidate items, wherein:
the subset of the plurality of interface elements includes interface elements of the plurality of interface elements having a highest ranking; and
generating a set of instructions to cause the subset of the of the plurality of interface elements to be displayed in conjunction with the corresponding the at least one of the one or more candidate items on a user interface.

12. The computer implemented method of claim 11, comprising inputting a data set comprising item attributes to a tree-based neural network and, in response, generating the plurality of interface elements for the at least one of one or more candidate items.

13. The computer implemented method of claim 12, wherein the tree-based neural network includes a plurality of trained decision trees, the computer implemented method comprising inputting at least a portion of the data set to each of the plurality of trained decision trees.

14. The computer implemented method of claim 11, comprising executing an artificial neural network and, in response, generating the plurality of interface elements for the at least one of one or more candidate items.

15. The computer implemented method of claim 14, comprising
receiving a training data set;
inputting the training data set into an untrained artificial neural network and, in response, adjusting one or more parameters of the untrained artificial neural network;
determining that the artificial neural network is trained based on the adjusted one or more parameters; and
storing the adjusted one or more parameters in a database, wherein the adjusted one or more parameters characterize the artificial neural network.

16. A non-transitory computer-readable storage medium comprising executable instructions that, when executed by one or more processors of a computing device, cause the one or more processors to:
receive a request for one or more interface elements associated with at least one of one or more candidate items;
generate a user affinity score for each of the one or more candidate interface elements based on user historical user interaction data;
generate a candidate item affinity score for each of the at least one of one or more candidate items and each of the one or more candidate interface elements based on historical item interaction data; and
responsive to the request for one of or more interface elements:
generate a combined affinity score for each candidate item of the at least one of one or more candidate items, wherein the combined affinity score is generated by combining the user affinity score and the candidate item affinity score for each of the one or more candidate interface elements;
generate a plurality of interface elements for the at least one of one or more candidate items;
rank the plurality of interface elements based on the combined affinity score for each of the interface elements and for each of the at least one of one or more candidate items;
select a subset of the plurality of interface elements for the at least one of one or more candidate items, wherein:
the subset of the plurality of interface elements includes interface elements of the plurality of interface elements having a highest ranking; and
generate a set of instructions to cause the subset of the of the plurality of interface elements to be displayed in conjunction with the corresponding the at least one of the one or more candidate items on a user interface.

17. The non-transitory computer-readable storage medium of claim 16 comprising executable instructions that, when executed by the one or more processors of the computing device, cause the one or more processors to input a data set comprising item attributes to a tree-based neural network and, in response, generate the plurality of interface elements for the at least one of one or more candidate items.

18. The system of claim 17, wherein the tree-based neural network includes a plurality of trained decision trees, and wherein the processor is configured to read the instructions to input at least a portion of the data set to each of the plurality of trained decision trees.

19. The non-transitory computer-readable storage medium of claim 16 comprising executable instructions that, when executed by the one or more processors of the computing device, cause the one or more processors to execute an artificial neural network and, in response, generate the plurality of interface elements for the at least one of one or more candidate items.

20. The non-transitory computer-readable storage medium of claim 19 comprising executable instructions that, when executed by the one or more processors of the computing device, cause the one or more processors to:
receive a training data set;
input the training data set into an untrained artificial neural network and, in response, adjust one or more parameters of the untrained artificial neural network;
determine that the artificial neural network is trained based on the adjusted one or more parameters; and
store the adjusted one or more parameters in a database, wherein the adjusted one or more parameters characterize the artificial neural network.
